(19) United States
(12) Patent Application Publication
(10) Pub. No.: US 2026/0248144 A1
(43) Pub. Date: Aug. 27, 2026

(54) PIZZA TOPPING SPREADER

(71) Applicant: YINDU KITCHEN EQUIPMENT CO., LTD., Hangzhou (CN)

(72) Inventor: Junjie ZHOU, Hangzhou (CN)

(73) Assignee: YINDU KITCHEN EQUIPMENT CO., LTD., Hangzhou (CN)

(21) Appl. No.: 19/292,985

(22) Filed: Aug. 7, 2025

(30) Foreign Application Priority Data
Feb. 27, 2025 (CN) 202510220772.4

(51) Int. Cl. A21C 9/04; A22C 17/00; G01G 19/52

(52) U.S. Cl. CPC A21C 9/04; A22C 17/0033; G01G 19/52

(57) ABSTRACT

A pizza topping spreader is provided. The pizza topping spreader includes a mounting base, a sausage storage assembly, a sausage slicing assembly, a sauce application assembly and a pizza crust carrier assembly, where the sausage slicing assembly, the sauce application assembly and the pizza crust carrier assembly are all provided on the mounting base; the sausage slicing assembly includes a sausage slicing base, a sausage slicing member, a sausage rotating member, a sausage slice feeding channel and a slicing vibration member, the sausage slicing base is provided on the mounting base, a sausage feeding port is provided on the sausage slicing base, the sausage slice feeding channel is provided at the sausage feeding port through the slicing vibration member, the sausage slicing member and the sausage rotating member are both provided on the sausage slicing base.

### CROSS-REFERENCE TO THE RELATED APPLICATIONS

This application is based upon and claims priority to Chinese Patent Application No. 202510220772.4, filed on Feb. 27, 2025, the entire contents of which are incorporated herein by reference.

### TECHNICAL FIELD

The present disclosure relates to the technical field of pizza production equipment, in particular to a pizza topping spreader.

### BACKGROUND

Pizza is a food originated in Italy and is very popular around the world. The usual method of making pizza is to cover fermented round dough with tomato sauce, cheese, meat, vegetables and other toppings, and then bake it in an oven.

With the development of society, in order to increase the speed of serving and control the quality of products, more and more merchants choose to make semi-finished pizzas first. After ordering, they only need to bake the semi-finished pizzas. During the pizza production process, different toppings need to be spread on the pizza dough.

In the prior art, the semi-finished pizza is semi-automatically produced, with round dough processed by machines and then spread manually, which has low production efficiency.

### SUMMARY

The purpose of the present disclosure is to provide a pizza topping spreader to alleviate the technical problems in the prior art.

In the first aspect, an embodiment of the present disclosure provides a pizza topping spreader, including a mounting base, a sausage storage assembly, a sausage slicing assembly, a sauce application assembly and a pizza crust carrier assembly;

the sausage slicing assembly, the sauce application assembly and the pizza crust carrier assembly are all provided on the mounting base, and the pizza crust carrier assembly is located below the sausage slicing assembly and the sauce application assembly;

the sausage slicing assembly includes a sausage slicing base, a sausage slicing member, a sausage rotating member, a sausage slice feeding channel and a slicing vibration member, where the sausage slicing base is provided on the mounting base, a sausage feeding port is provided on the sausage slicing base, the sausage slice feeding channel is provided at the sausage feeding port through the slicing vibration member, the sausage slicing member and the sausage rotating member are both provided on the sausage slicing base, and the sausage slicing member and the sausage rotating member are respectively provided on both sides of the sausage feeding port; and

the sausage storage assembly is mounted on the sausage rotating member.

In combination with the first aspect, an embodiment of the present disclosure provides a possible embodiment of the first aspect, wherein the above-mentioned sausage slicing member includes a sausage slicing motor and a sausage slicing knife; and

the sausage slicing motor is provided at a bottom of the sausage slicing base, the sausage slicing knife is connected to the sausage slicing motor in a transmission manner, the sausage slicing knife is located above the sausage slicing base, and a knife protection cover for covering the sausage slicing knife is provided on the sausage slicing base.

In combination with the first aspect, an embodiment of the present disclosure provides a possible embodiment of the first aspect, wherein the above-mentioned sausage rotating member includes a sausage rotating motor, a sausage rotating shaft and a sausage rotating quick-release seat;

the sausage rotating motor is provided at the bottom of the sausage slicing base, the sausage rotating shaft is connected to the sausage rotating quick-release seat, and the sausage rotating quick-release seat is located above the sausage slicing base;

a C-shaped carrier seat for carrying sausages is provided on the sausage slicing base and located outside the sausage rotating quick-release seat, a notch of the C-shaped carrier seat corresponds to the sausage feeding port, a bottom surface of the sausage slicing knife is located below a top surface of the C-shaped carrier seat, and a top surface of the sausage slicing knife is located above the top surface of the C-shaped carrier seat; and

the sausage slicing member also includes a slicing anti-drop seat, where the slicing anti-drop seat is detachably provided on the sausage slicing base, the slicing anti-drop seat is located at an edge of the sausage feeding port, the slicing anti-drop seat is adjacent to the C-shaped carrier seat, and when the sausage slicing knife rotates, it first passes through the sausage feeding port and then faces towards the slicing anti-drop seat.

In combination with the first aspect, an embodiment of the present disclosure provides a possible embodiment of the first aspect, wherein the above-mentioned sausage storage assembly includes a sausage carrier bracket, a sausage positioning member and a sausage auxiliary positioning plate;

the sausage carrier bracket is provided on the sausage rotating quick-release seat;

the sausage carrier bracket has a plurality of guide posts, each of the guide posts is slidably provided with the sausage positioning member, and the sausage positioning member can fix an upper end of the sausage;

the sausage auxiliary positioning plate is slidably provided on the guide post, and the sausage auxiliary positioning plate can define a lower end of the sausage;

the sausage auxiliary positioning plate and the sausage positioning member both can slide separately; and

the sausage auxiliary positioning plate is provided with a plurality of sausage spaces for accommodating the sausages.

In combination with the first aspect, an embodiment of the present disclosure provides a possible embodiment of the first aspect, wherein the above-mentioned sausage carrier bracket includes a sausage carrier base, a sausage carrier top plate and a plurality of the guide posts;

one end of the guide post is provided on the sausage carrier base, and the other end is provided on the sausage carrier top plate;

the plurality of guide posts are evenly distributed along a circumferential direction of the sausage carrier base; and

a quick-release interface that can be adapted to the sausage rotating quick-release seat is provided on the sausage carrier base.

In combination with the first aspect, an embodiment of the present disclosure provides a possible embodiment of the first aspect, wherein the above-mentioned sausage positioning member includes a counterweight seat, a sausage fixing clip and a sausage top fixing seat;

the counterweight seat is slidably provided on the guide post, the counterweight seat is located above the sausage auxiliary positioning plate, the sausage auxiliary positioning plate can support the counterweight seat to rise, the sausage fixing clip is fixedly provided on the counterweight seat, the sausage fixing clip can clamp the sausage, the sausage top fixing seat is fixedly provided on the counterweight seat, and the sausage top fixing seat can fix a top of the sausage; and

the sausage top fixing seat includes a sausage top plate and a sausage fixing nail, where the sausage top plate is fixedly provided on the counterweight seat, the sausage fixing nail is provided on the sausage top plate, and the sausage fixing nail can be inserted into the sausage from the top of the sausage.

In combination with the first aspect, an embodiment of the present disclosure provides a possible embodiment of the first aspect, wherein the above-mentioned sauce application assembly includes a sauce storage member, a sauce discharge member, a sauce power member, an applicator and an application drive member;

the sauce storage member is provided on the mounting base, the sauce discharge member is provided on the mounting base, the sauce discharge member is connected to the sauce storage member through the sauce power member, the application drive member is provided on the mounting base, the applicator is provided at a bottom of the mounting base, and the applicator is connected to the application drive member in a transmission manner; and

the sauce discharge member adopts a discharge pipe, the mounting base is provided with a mounting hole for mounting the sauce discharge member, and an end of the discharge pipe is provided with a plurality of pressure relief grooves, where an extension direction of the pressure relief grooves is consistent with an extension direction of the discharge pipe.

In combination with the first aspect, an embodiment of the present disclosure provides a possible embodiment of the first aspect, wherein the above-mentioned applicator includes an application base and an application scraper;

the application base is provided on the mounting base, the application drive member is provided on the application base, and the application scraper is connected to the application drive member in a transmission manner, so that the application drive member can drive the application scraper to swing; and

the application base is provided at the bottom of the mounting base, and a mounting cavity for mounting the application drive member is formed between the application base and the mounting base.

In combination with the first aspect, an embodiment of the present disclosure provides a possible embodiment of the first aspect, wherein the above-mentioned the pizza crust carrier assembly includes a first direction moving member, a second direction moving member, a pizza rotating member, a pizza supporting base and a weighing member;

the first direction moving member is provided on the mounting base, the second direction moving member is provided on the first direction moving member, the first direction intersects with the second direction, the pizza rotating member is provided on the second direction moving member, the pizza supporting base is provided on the pizza rotating member, and the weighing member is provided between the pizza supporting base and the pizza rotating member; and

the pizza rotating member includes a rotating base, a pizza rotating motor, a rotating socket and a rotating drive shaft, where the rotating base is provided on the second direction moving member, the pizza rotating motor is provided on the rotating base, the pizza rotating motor is connected to the rotating socket in a transmission manner, the rotating drive shaft is inserted in the rotating socket, and the pizza supporting base is provided on the rotating drive shaft.

In combination with the first aspect, an embodiment of the present disclosure provides a possible embodiment of the first aspect, wherein the above-mentioned weighing member includes a weighing base, a weighing sensor and a weighing protective sleeve;

the weighing base is provided on the rotating base, the weighing protective sleeve is fixedly provided at a bottom end of the rotating drive shaft, the weighing sensor is provided in the weighing protective sleeve, and the weighing sensor can abut against the weighing base;

a weighing guide post is provided on the weighing base, a weighing guide hole for the weighing guide post to pass therethrough is provided on the rotating base, and a limit stop seat is provided at one end of the weighing guide post away from the weighing base; and

a lifting follower pulley is provided on the weighing base, and a lifting trapezoidal seat that can be adapted to the lifting follower pulley is provided on the second direction base of the second direction moving member, so that the pizza supporting base can be lifted upward when receiving toppings, and the pizza supporting base can be lowered when receiving the pizza crust.

### BENEFICIAL EFFECTS

The embodiments of the present disclosure provide a pizza topping spreader, including a mounting base, a sausage storage assembly, a sausage slicing assembly, a sauce application assembly and a pizza crust carrier assembly, where the sausage slicing assembly, the sauce application assembly and the pizza crust carrier assembly are all provided on the mounting base, and the pizza crust carrier assembly is located below the sausage slicing assembly and the sauce application assembly; the sausage slicing assembly includes a sausage slicing base, a sausage slicing member, a sausage rotating member, a sausage slice feeding channel and a slicing vibration member, where the sausage slicing base is provided on the mounting base, a sausage feeding port is provided on the sausage slicing base, the sausage slice feeding channel is provided at the sausage feeding port through the slicing vibration member, the sausage slicing member and the sausage rotating member are both provided on the sausage slicing base, and the sausage slicing member and the sausage rotating member are respectively provided on both sides of the sausage feeding port; and the sausage storage assembly is mounted on the sausage rotating member.

Specifically, when in use, the staff mounts the sausage storage assembly on the sausage rotating member, then the sausage rotating member drives the sausage slicing storage member to rotate, and then the sausage slicing member operates to slice the sausage, and the sausage slices will drop into the sausage slice feeding channel. Under an action of the slicing vibration member, the sausage slice feeding channel enables the sausage slices to drop smoothly along the sausage slice feeding channel, and the sausage slices will not stick to the sausage slice feeding channel, thereby ensuring the operating efficiency of the sausage slicing. The sliced sausage slices drop on the pizza crust supported by the pizza crust carrier assembly, and then the pizza crust carrier assembly drives the pizza crust to move to under the sauce application assembly, and the sauce application assembly applies the sauce on the pizza crust. Through such configuration, the production efficiency is improved.

### BRIEF DESCRIPTION OF THE DRAWINGS

In order to more clearly illustrate specific embodiments of the present disclosure or technical solutions in the prior art, the following will briefly introduce drawings required for the specific embodiments or the prior art description. Obviously, the drawings described below are some embodiments of the present disclosure. For those ordinarily skilled in the art, other drawings can also be obtained based on these drawings without creative work.

FIG. 1 is a structural schematic diagram of a pizza topping spreader provided by an embodiment of the present disclosure;

FIG. 2 is an internal structural schematic diagram of a pizza topping spreader provided by an embodiment of the present disclosure;

FIG. 3 is an internal schematic diagram of a pizza topping spreader provided by an embodiment of the present disclosure;

FIG. 4 is a structural schematic diagram of a sausage storage assembly and a sausage slicing assembly in a pizza topping spreader provided by an embodiment of the present disclosure;

FIG. 5 is a structural schematic diagram of a sausage storage assembly in a pizza topping spreader provided by an embodiment of the present disclosure;

FIG. 6 is a top view of a sausage slicing assembly in a pizza topping spreader provided by an embodiment of the present disclosure;

FIG. 7 is a sectional view of A-A in FIG. 6;

FIG. 8 is a sectional view of B-B in FIG. 6;

FIG. 9 is a partial schematic diagram of a sausage slicing assembly in a pizza topping spreader provided by an embodiment of the present disclosure;

FIG. 10 is a bottom schematic diagram of a sausage slicing assembly in a pizza topping spreader provided by an embodiment of the present disclosure;

FIG. 11 is a structural schematic diagram of a sauce application assembly in a pizza topping spreader provided by an embodiment of the present disclosure;

FIG. 12 is a structural schematic diagram of a sauce discharge member and an applicator of a sauce application assembly in a pizza topping spreader provided by an embodiment of the present disclosure;

FIG. 13 is a schematic diagram of the sauce discharge member and the applicator of the sauce application assembly in the pizza topping spreader provided in the embodiment of the present disclosure;

FIG. 14 is an internal schematic diagram of the sauce discharge member and the applicator of the sauce application assembly in the pizza topping spreader provided by the embodiment of the present disclosure;

FIG. 15 is a structural schematic diagram of a pizza crust carrier assembly in the pizza topping spreader provided by the embodiment of the present disclosure;

FIG. 16 is a schematic diagram of a pizza rotating member, a pizza supporting base and a weighing member of the pizza crust carrier assembly in the pizza topping spreader provided in the embodiment of the present disclosure;

FIG. 17 is a sectional view of the pizza rotating member, the pizza supporting base and the weighing member of the pizza crust carrier assembly in the pizza topping spreader provided in the embodiment of the present disclosure;

FIG. 18 is a bottom schematic diagram of the pizza rotating member, the pizza supporting base and the weighing member of the pizza crust carrier assembly in the pizza topping spreader provided in the embodiment of the present disclosure;

FIG. 19 is a structural schematic diagram of a block material spreading member in the pizza topping spreader provided in the embodiment of the present disclosure; and

FIG. 20 is an internal schematic diagram of a block material barrel of the block material spreading member in the pizza topping spreader provided in the embodiment of the present disclosure.

### REFERENCE SIGNS

10-mounting base;

100-sausage storage assembly; 110-sausage carrier bracket; 111-guide post; 112-sausage carrier base; 113-sausage carrier top plate; 114-quick-release interface; 120-sausage positioning member; 121-counterweight seat; 122-sausage fixing clip; 123-sausage top fixing seat; 124-sausage top plate; 125-sausage fixing nail; 130-sausage auxiliary positioning plate; 131-sausage space; 140-sausage;

200-sausage slicing assembly; 210-sausage slicing base; 211-sausage feeding port; 212-knife protection cover; 213-C-shaped carrier seat; 220-sausage slicing member; 221-sausage slicing motor; 222-sausage slicing knife; 223-slicing anti-drop seat; 230-sausage rotating member; 231-sausage rotating motor; 232-sausage rotating shaft; 233-sausage rotating quick-release seat; 240-sausage slice feeding channel; 250-slicing vibration member; 251-vibration motor; 252-vibration base;

300-sauce application assembly; 310-sauce storage member; 320-sauce discharge member; 321-mounting hole; 322-pressure relief groove; 330-applicator; 331-application base; 332-application scraper; 333-mounting cavity; 340-application drive member;

400-pizza crust carrier assembly; 410-pizza rotating member; 411-rotating base; 412-pizza rotating motor; 413-rotating socket; 414-rotating drive shaft; 420-pizza supporting base; 421-carrier ring seat; 430-weighing member; 431-weighing base; 432-weighing sensor; 433-weighing protective sleeve; 434-weighing guide post; 435-limit stop seat; 436-lifting follower pulley; 437-lifting trapezoidal seat; 440-first direction moving member; 441-first direction drive motor; 442-first direction base; 450-second direction moving member; 451-second direction lead screw; 452-second direction lead screw nut; 453-second direction drive motor; 454-second direction base;

500-block material spreading member; 510-block material barrel; 511-material discharge port; 520-block material drive motor; 530-block material auger; 540-block material feeding winch.

### DETAILED DESCRIPTION OF THE EMBODIMENTS

The technical solutions of the present disclosure will be described clearly and completely below with reference to the drawings. Obviously, the described embodiments are part of the embodiments of the present disclosure, not all of the embodiments. Based on the embodiments of the present disclosure, all other embodiments obtained by those ordinarily skilled in the art without creative work belong to the scope of protection of the present disclosure.

In the description of the present disclosure, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and the like indicate the orientation or position relationship based on the orientation or position relationship shown in the drawings, which is only for the convenience of describing the present disclosure and simplifying the description, rather than indicating or implying that the device or element referred to must have a specific orientation, be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of technical features indicated. Therefore, the features defined with “first” and “second” can explicitly or implicitly include one or more such features. In the description of the present disclosure, “multiple” means two or more than two, unless otherwise clearly defined.

In the present disclosure, unless otherwise clearly specified and defined, the terms “mount”, “connect”, “couple”, “fix” and the like should be understood in a broad sense. For example, it can be a fixed connection, a detachable connection, or an integral one; it can be a mechanical connection or an electrical connection; it can be directly connected or indirectly connected through an intermediate medium; and it can be the internal communication of two elements or the interaction relationship between two elements. For those ordinarily skilled in the art, the specific meanings of the above terms in the present disclosure can be understood according to specific situations.

The present disclosure is further described in detail below through specific embodiments and with reference to the drawings.

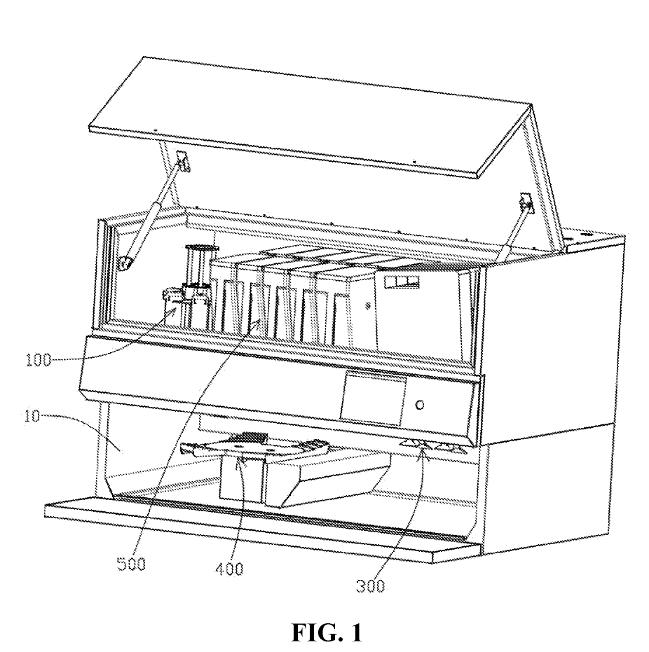

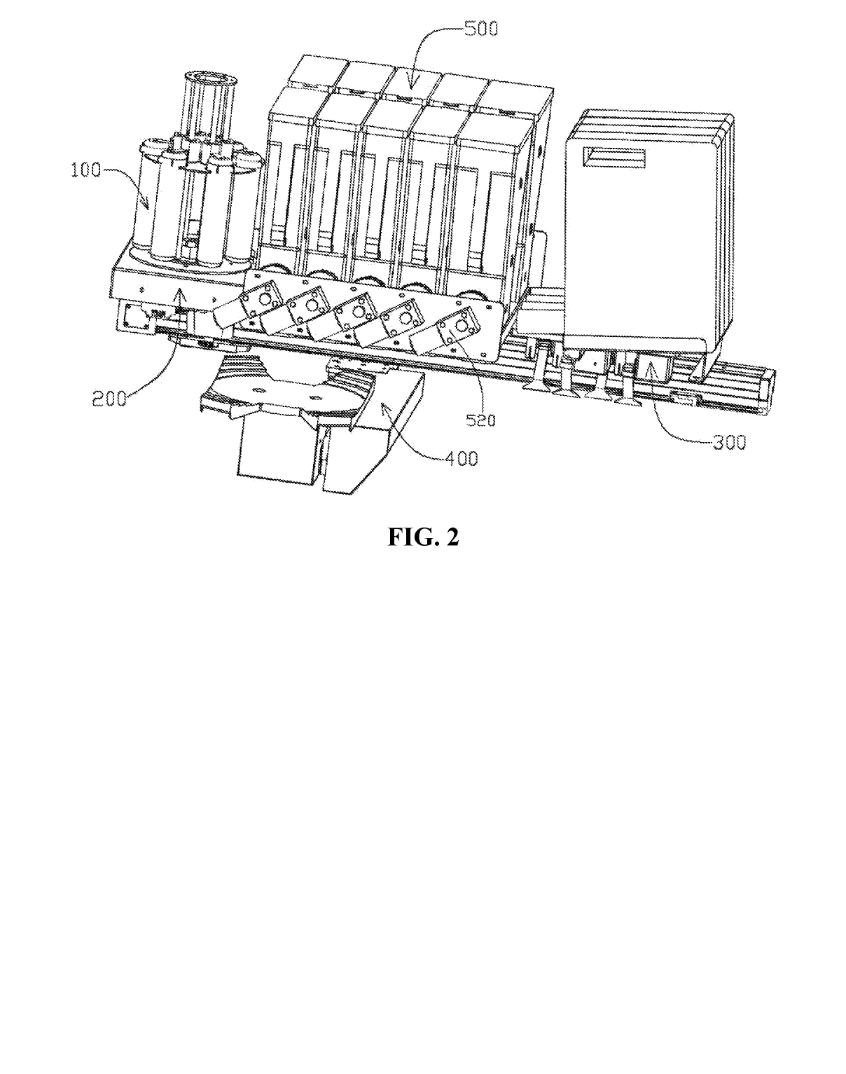

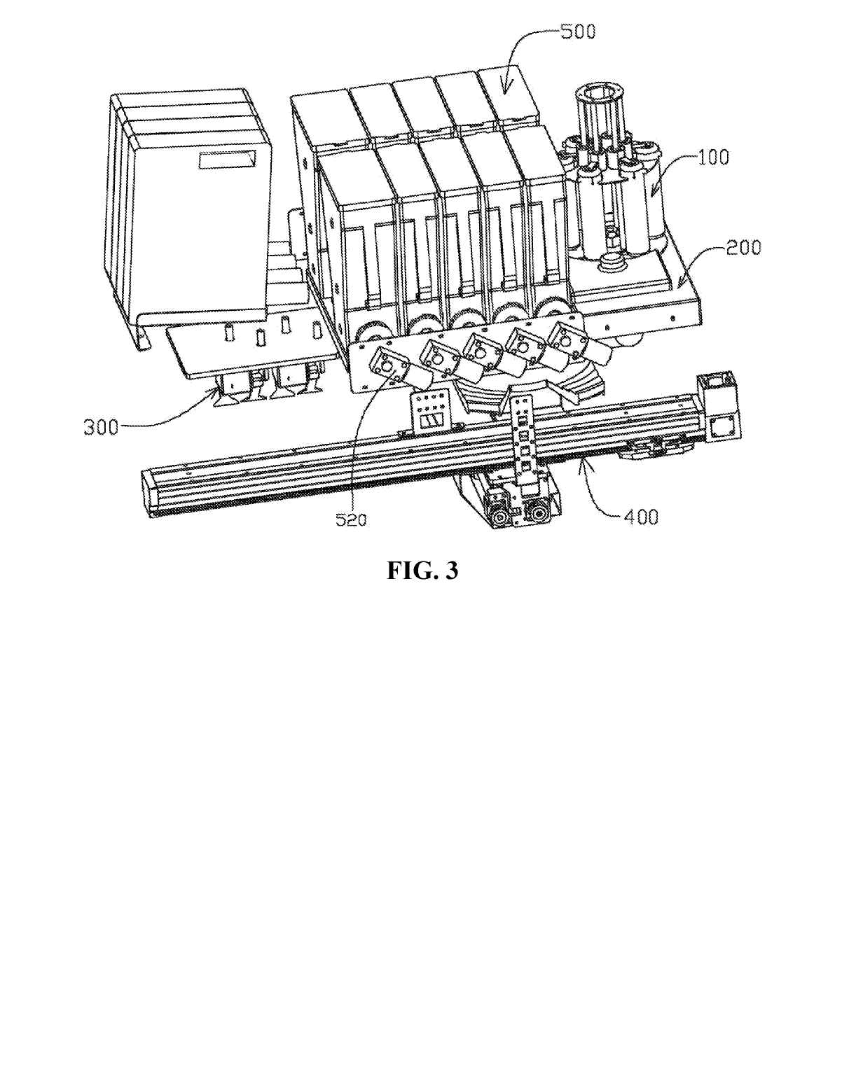

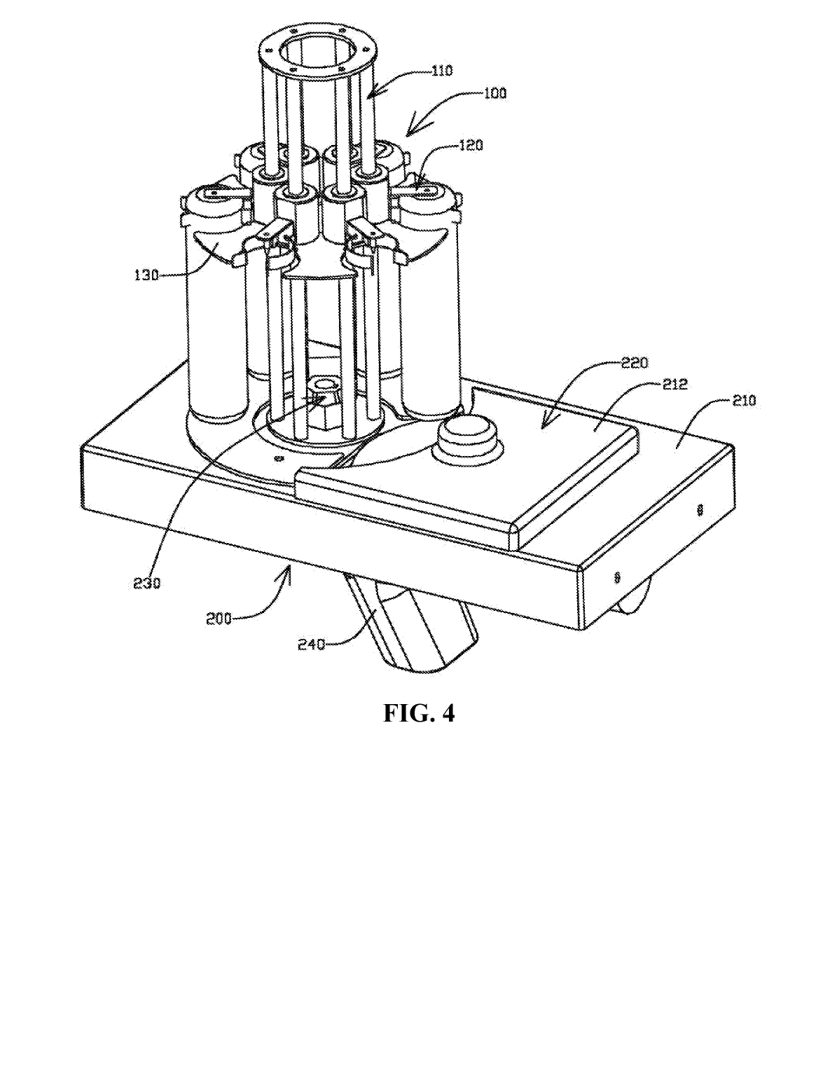

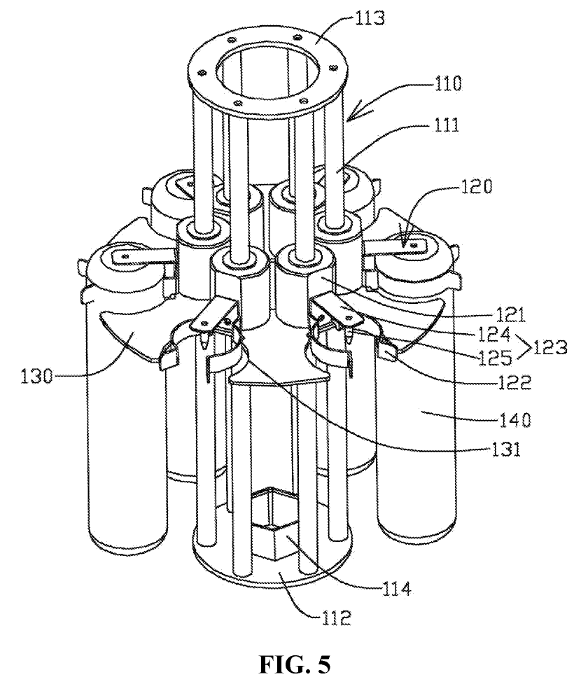

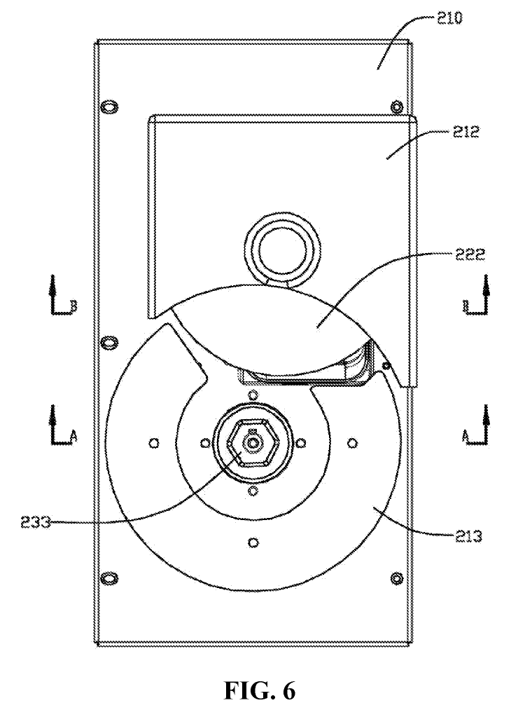

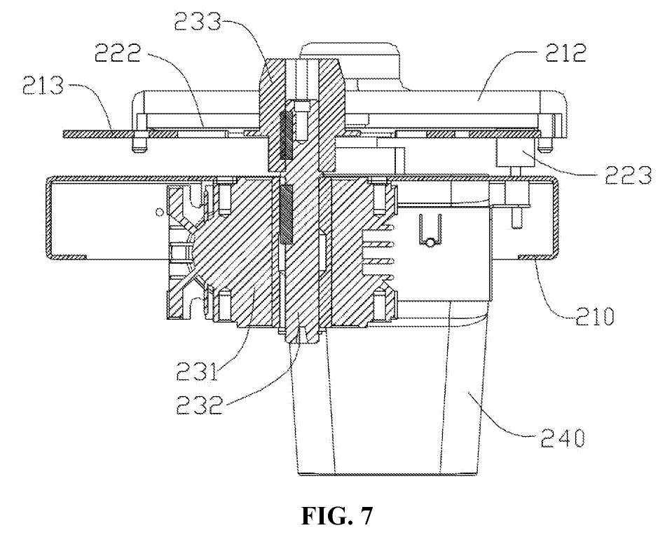

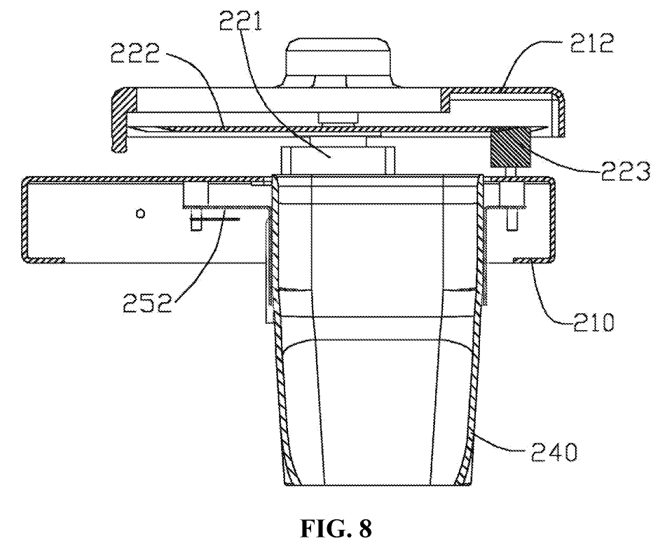

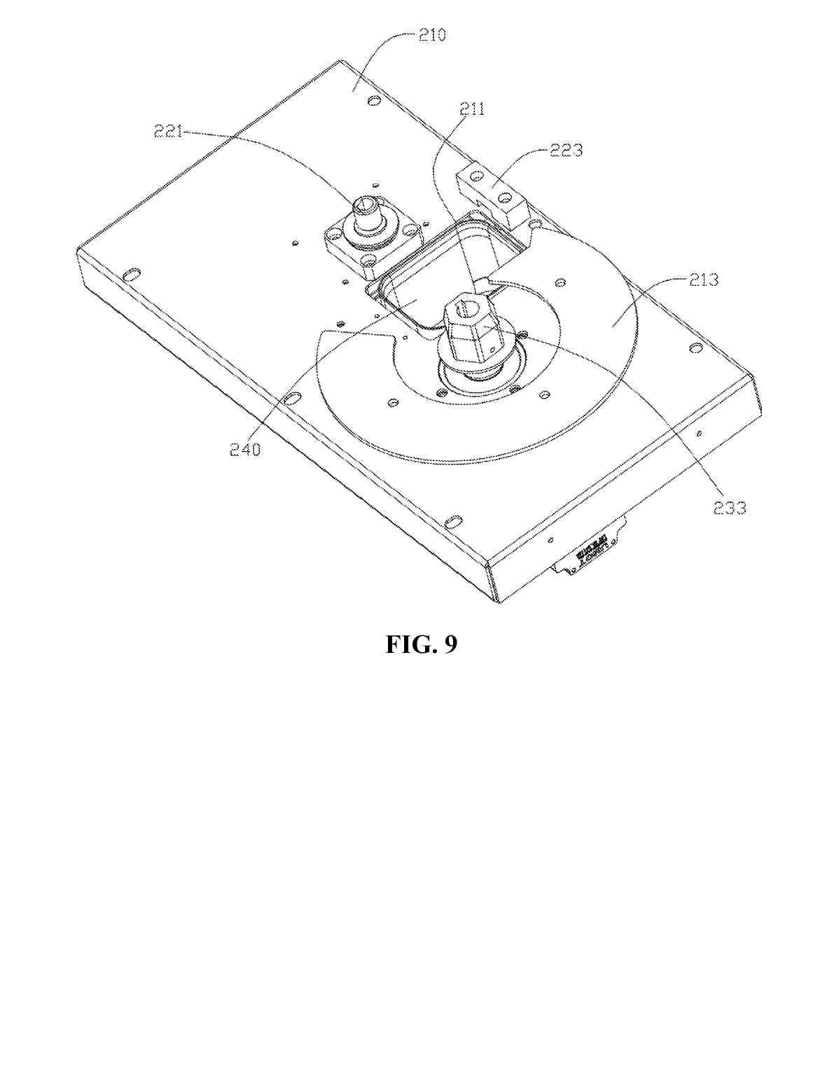

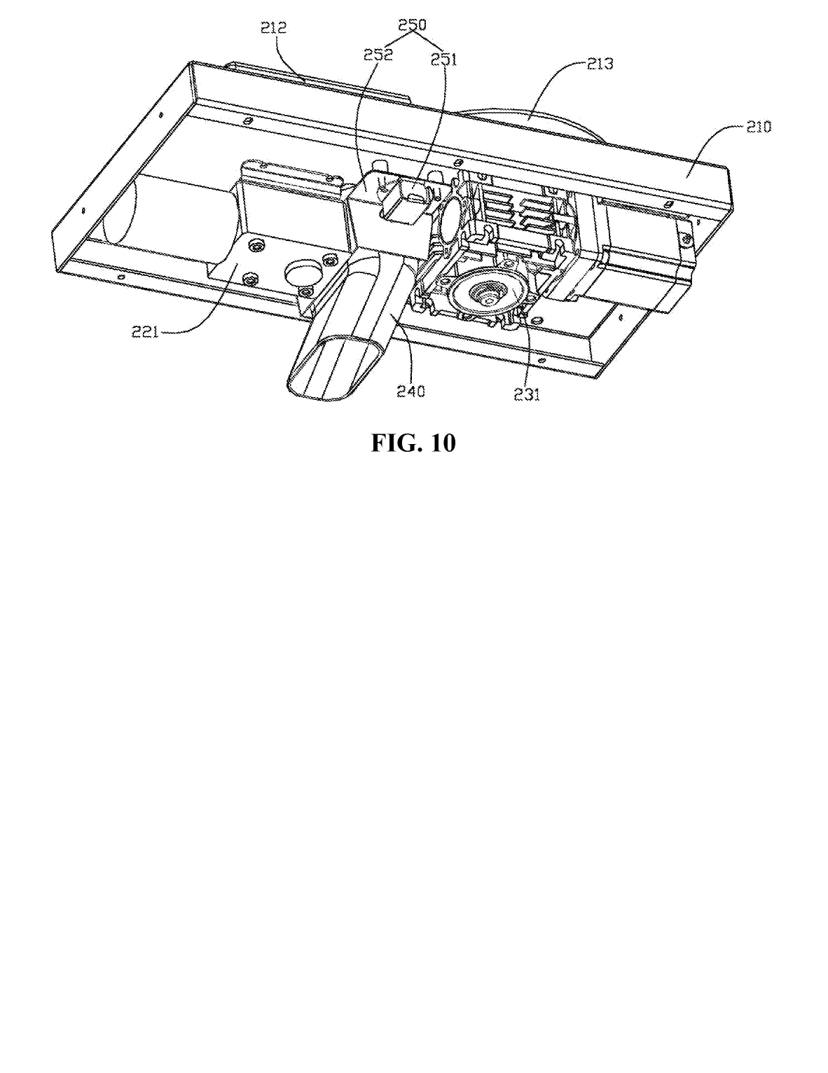

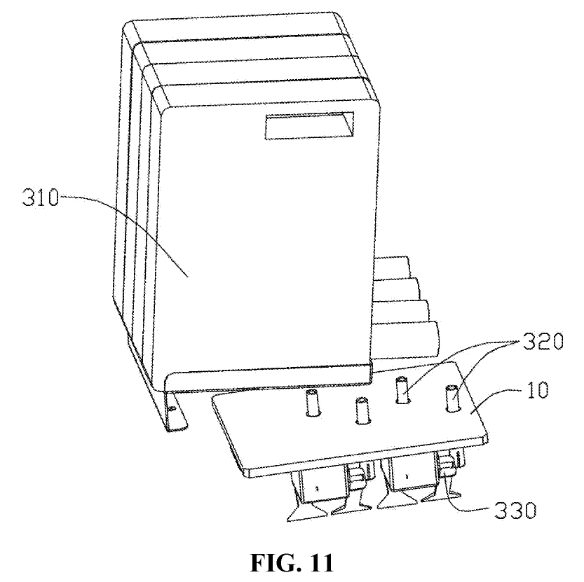

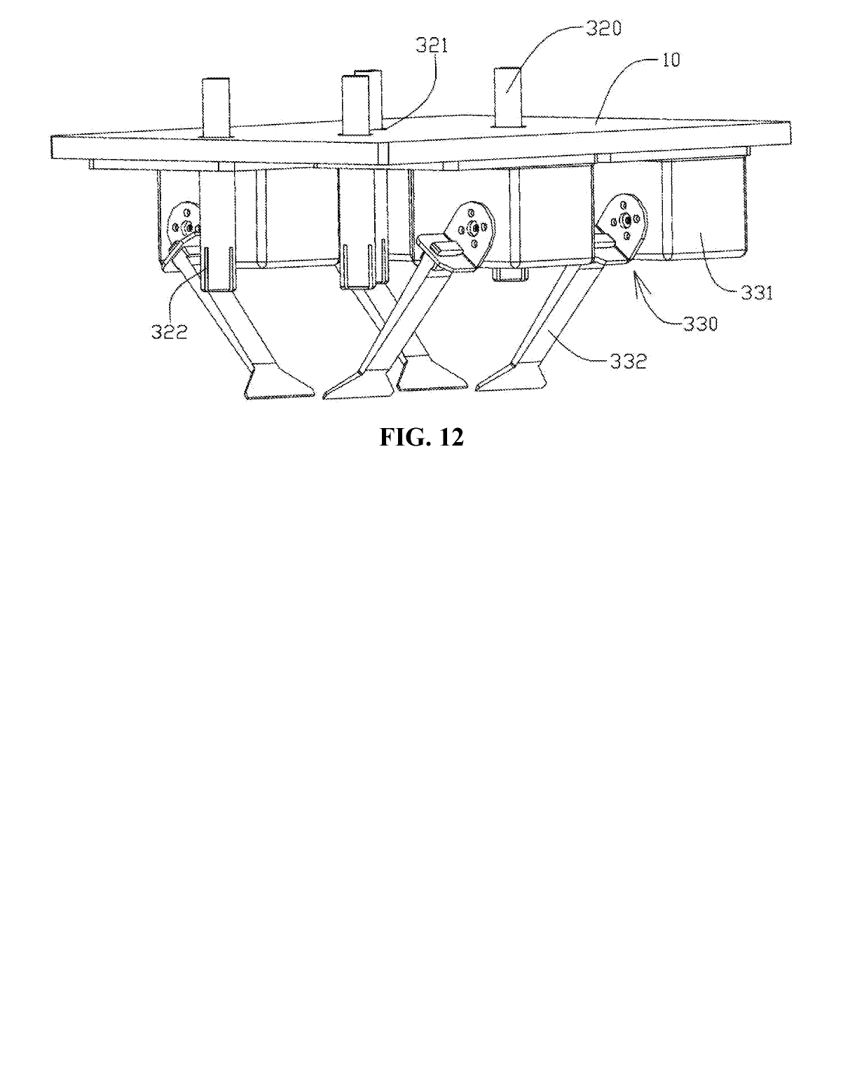

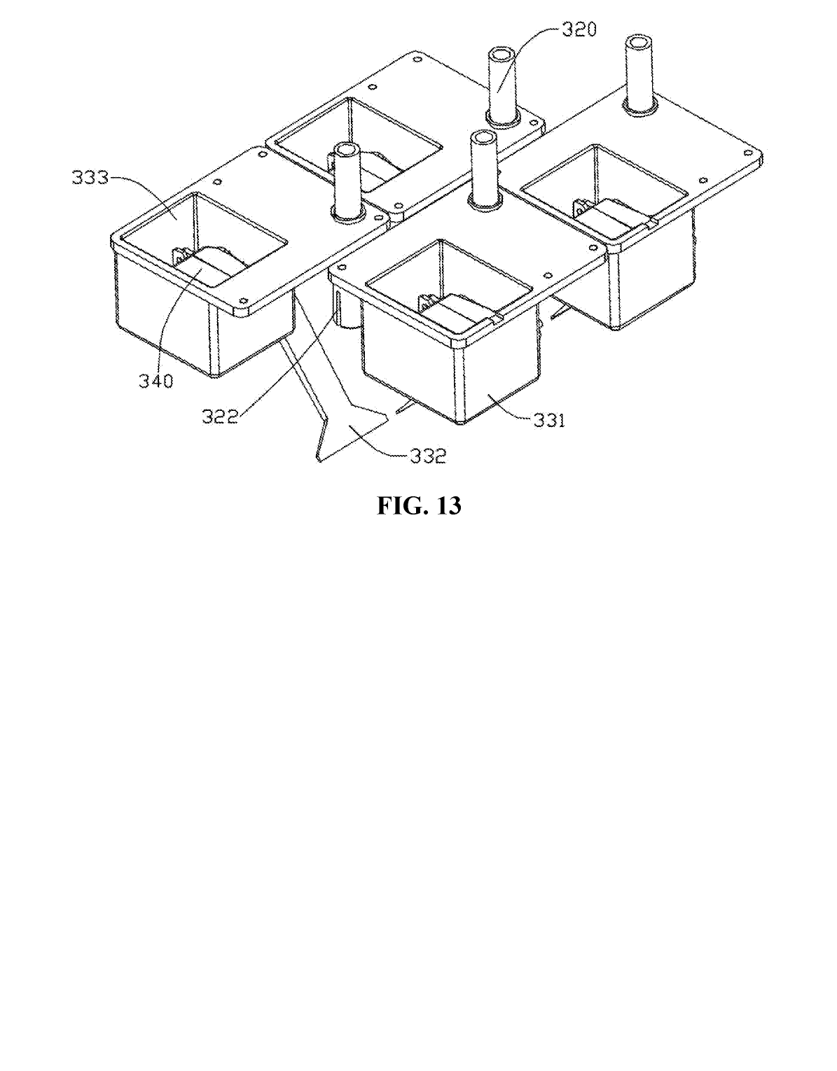

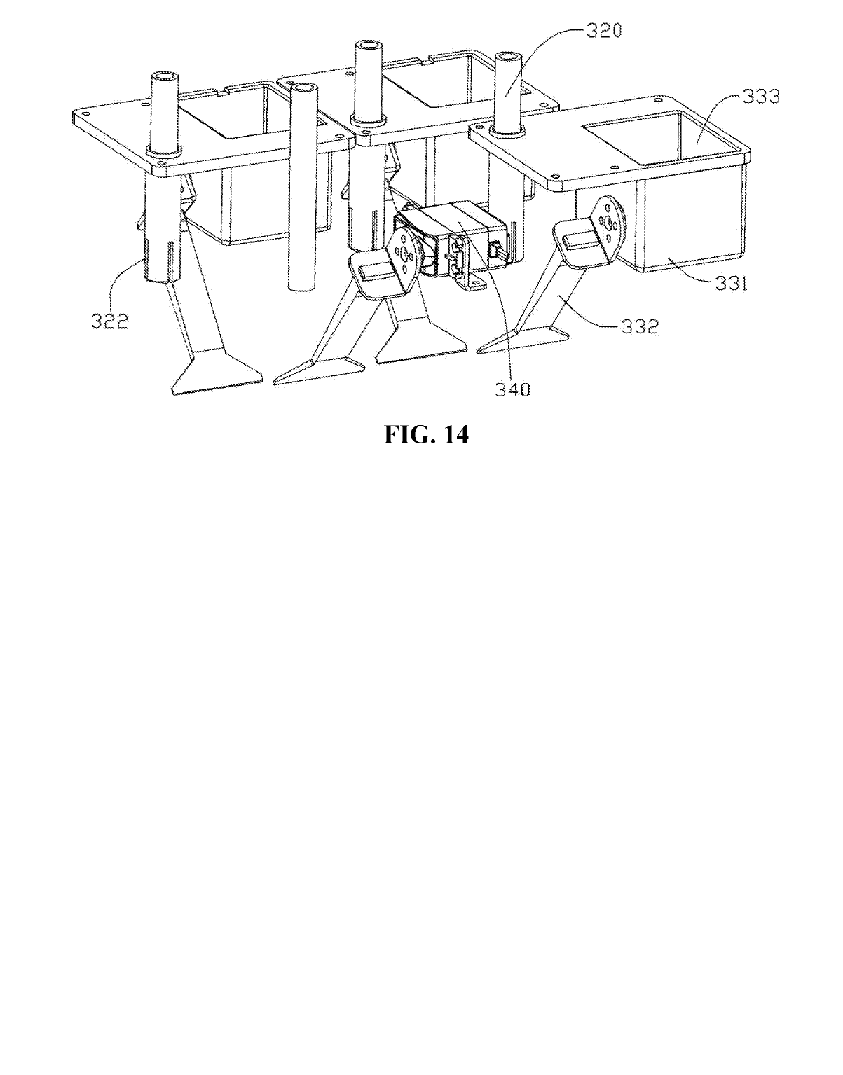

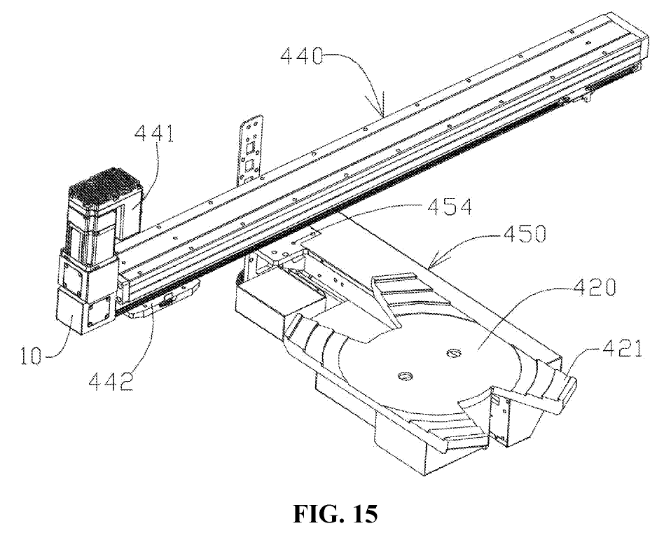

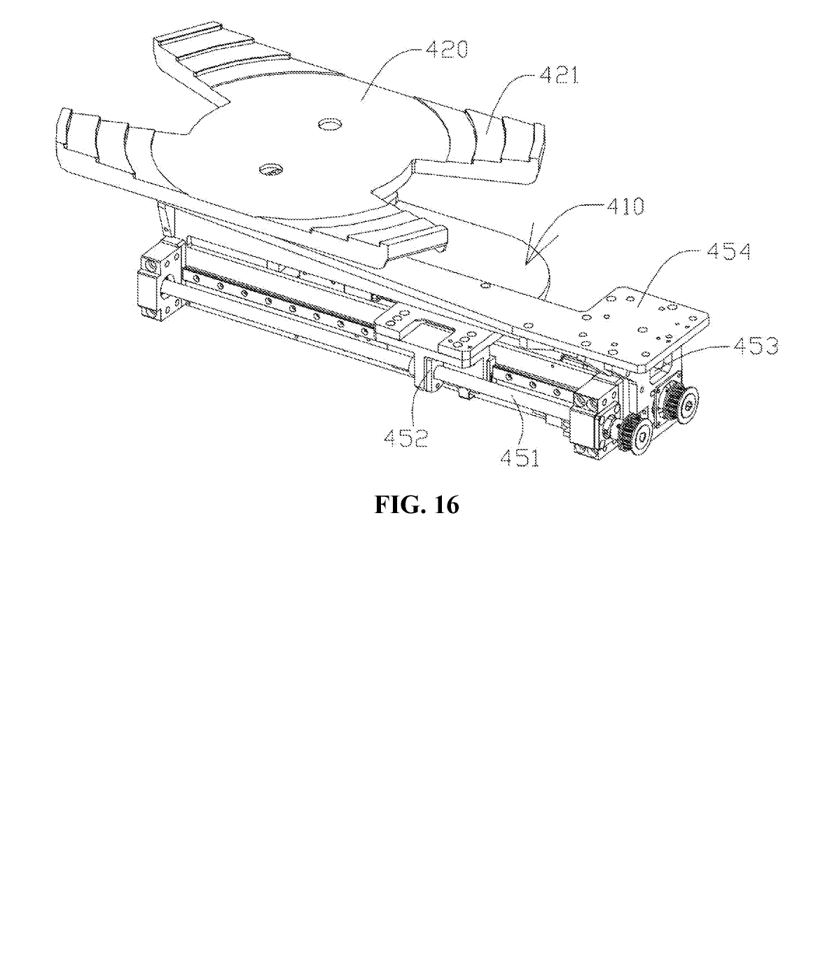

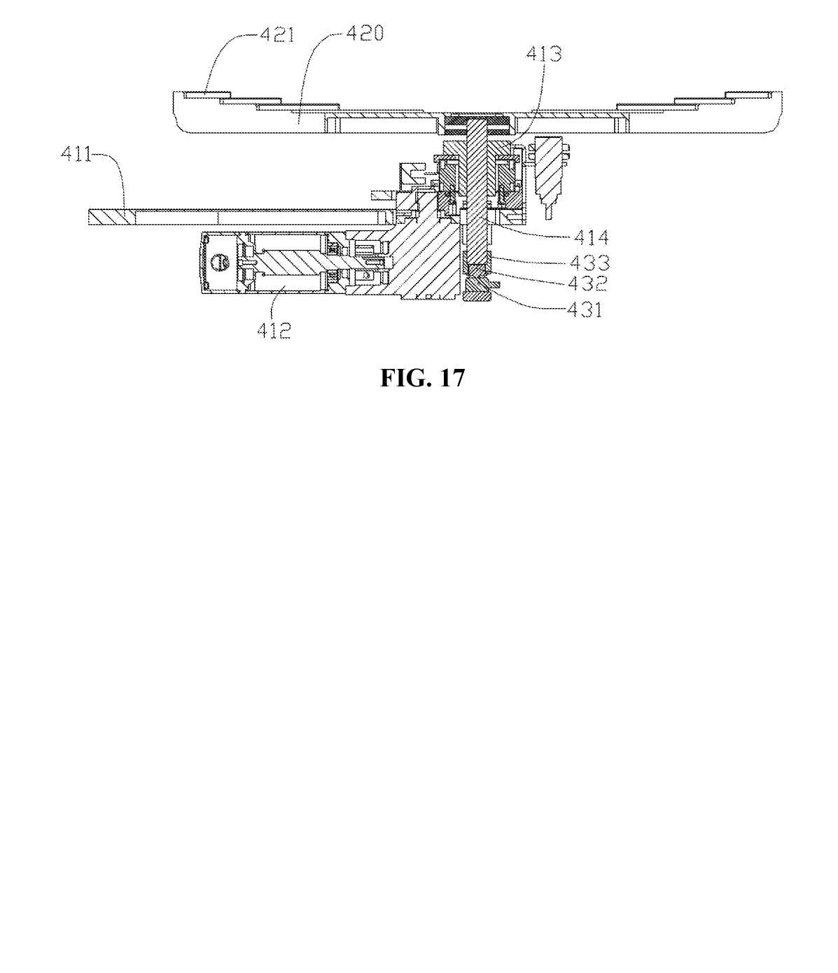

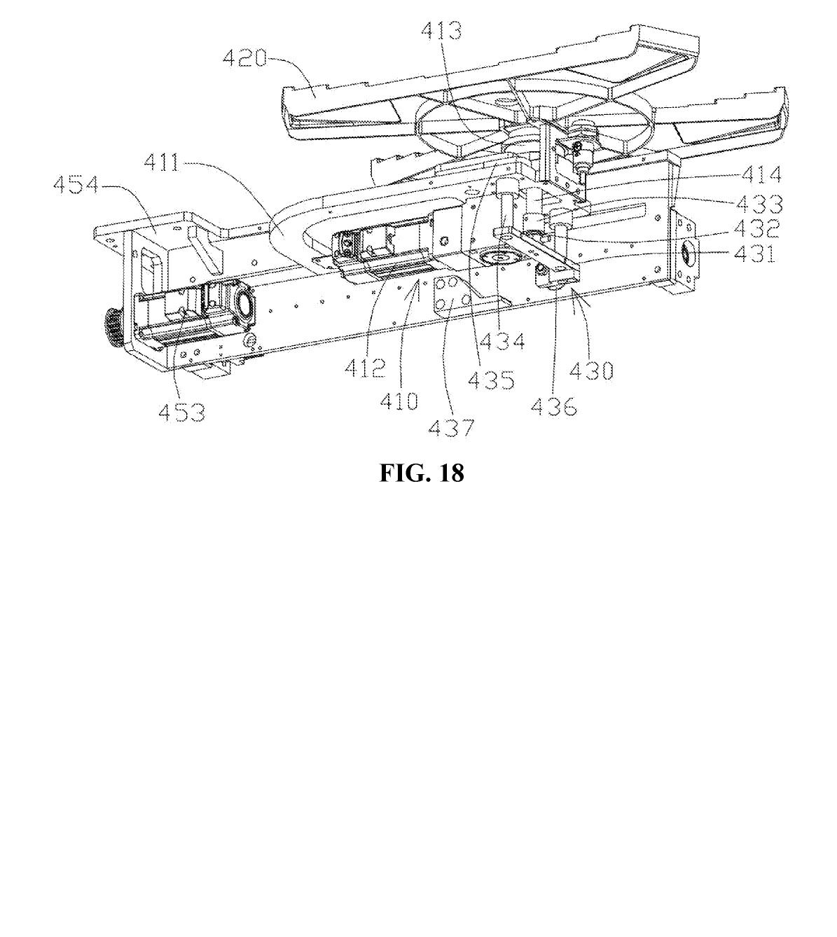

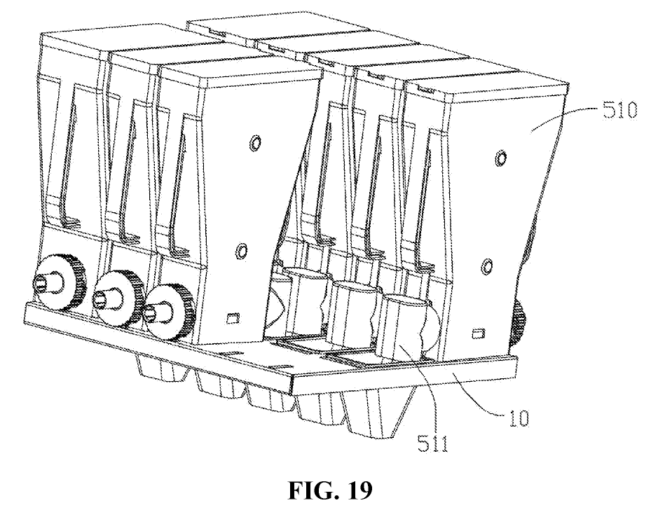

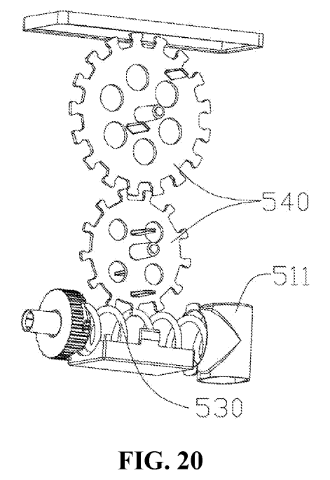

Referring to FIGS. 1, 2, 3, 4, 5, 6, 7, 8, 9, 10, 11, 12, 13, 14, 15, 16, 17, 18, 19 and 20, the present embodiment provides a pizza topping spreader, including a mounting base 10, a sausage storage assembly 100, a sausage slicing assembly 200, a sauce application assembly 300 and a pizza crust carrier assembly 400. The sausage slicing assembly 200, the sauce application assembly 300 and the pizza crust carrier assembly 400 are all provided on the mounting base 10, and the pizza crust carrier assembly 400 is located below the sausage slicing assembly 200 and the sauce application assembly 300. The sausage slicing assembly 200 includes a sausage slicing base 210, a sausage slicing member 220, a sausage rotating member 230, a sausage slice feeding channel 240 and a slicing vibration member 250. The sausage slicing base 210 is provided on the mounting base 10. A sausage feeding port 211 is provided on the sausage slicing base 210. The sausage slice feeding channel 240 is provided at the sausage feeding port 211 through the slicing vibration member 250. The sausage slicing member 220 and the sausage rotating member 230 are both provided on the sausage slicing base 210. The sausage slicing member 220 and the sausage rotating member 230 are respectively provided on both sides of the sausage feeding port 211. The sausage storage assembly 100 is mounted on the sausage rotating member 230.

Specifically, when in use, the sausage storage assembly 100 is mounted on the sausage rotating member 230 by the staff, then the sausage rotating member 230 drives a slicing storage member of the sausage 140 to rotate, and then the sausage slicing member 220 operates to slice the sausage 140, and the sausage 140 slices will drop into the sausage slice feeding channel 240. Under an action of the slicing vibration member 250, the sausage slice feeding channel 240 enables the sausage 140 slices to drop smoothly along the sausage slice feeding channel 240, and the sausage 140 slices will not stick to the sausage slice feeding channel 240, thereby ensuring operating efficiency of the sausage 140 slicing. The sliced sausage 140 slices drop on the pizza crust supported by the pizza crust carrier assembly 400, and then the pizza crust carrier assembly 400 drives the pizza crust to move to under the sauce application assembly 300, and the sauce application assembly 300 applies the sauce on the pizza crust. Through such configuration, production efficiency is improved.

In addition, the pizza topping spreader provided in the present embodiment also includes a block material spreading member 500, where the block material spreading member 500 includes a block material barrel 510, a block material drive motor 520, a block material auger 530 and a block material feeding winch 540. The block material barrel 510 is clamped on the mounting base 10. The block material feeding winch 540 is provided at an upper portion of the block material barrel 510. The block material auger 530 is provided at a lower portion of the block material barrel 510. The block material auger 530 can transfer the block material to a material discharge port 511 of the block material barrel 510. The block material drive motor 520 is provided on the mounting base 10. The block material drive motor 520 can be connected to the block material auger 530 in a transmission manner. The block material auger 530 can drive the block material feeding winch 540 to rotate, so that the block material drive motor 520 can drive the block material auger 530 and the block material feeding winch 540 to rotate, thereby completing a material discharge operation.

As shown in FIGS. 1 to 20, in an optional solution of the present embodiment, the sausage slicing member 220 includes a sausage slicing motor 221 and a sausage slicing knife 222. The sausage slicing motor 221 is provided at a bottom of the sausage slicing base 210. The sausage slicing knife 222 is connected to the sausage slicing motor 221 in a transmission manner, and the sausage slicing knife 222 is located above the sausage slicing base 210. The sausage slicing base 210 is provided with a knife protection cover 212 for covering the sausage slicing knife 222.

Specifically, the sausage slicing motor 221 can drive the disc-shaped sausage slicing knife 222 to rotate, and the sausage rotating member 230 drives the slicing storage member of the sausage 140 to rotate, so that the sausage slicing knife 222 slices the sausage 140. The sausage slicing knife 222 adopts a knife disc, and when the sausage slicing knife 222 rotates, it can better slice the sausage 140, so that edges of the sausage 140 slices are complete.

As shown in FIGS. 1 to 20, in an optional solution of the present embodiment, the sausage rotating member 230 includes a sausage rotating motor 231, a sausage rotating shaft 232 and a sausage rotating quick-release seat 233. The sausage rotating motor 231 is provided at the bottom of the sausage slicing base 210. The sausage rotating shaft 232 is connected to the sausage rotating quick-release seat 233. The sausage rotating quick-release seat 233 is located above the sausage slicing base 210. A C-shaped carrier seat 213 for carrying the sausage 140 is provided on the sausage slicing base 210 and located outside the sausage rotating quick-release seat 233. A notch of the C-shaped carrier seat 213 corresponds to the sausage feeding port 211. A bottom surface of the sausage slicing knife 222 is located below a top surface of the C-shaped carrier seat 213, and a top surface of the sausage slicing knife 222 is located above the top surface of the C-shaped carrier seat 213. The sausage slicing member 220 also includes a slicing anti-drop seat 223, where the slicing anti-drop seat 223 is detachably provided on the sausage slicing base 210, the slicing anti-drop seat 223 is located at an edge of the sausage feeding port 211, and the slicing anti-drop seat 223 is adjacent to the C-shaped carrier seat 213. When the sausage slicing knife 222 rotates, it first passes through the sausage feeding port 211 and then faces towards the slicing anti-drop seat 223.

Specifically, the slicing storage member of the sausage 140 is detachably mounted on the sausage rotating quick-release seat 233, and the sausage rotating motor 231 can drive the sausage rotating quick-release seat 233 to rotate, and cooperate with the rotation of the disc-shaped sausage slicing knife 222 to slice the rotating sausage 140. The C-shaped carrier seat 213 can limit a bottom of the sausage 140. When the sausage rotating member 230 rotates, the sausage 140 carried on the sausage rotating member 230 can be transferred to the notch of the C-shaped carrier seat 213. When the sausage 140 is transferred to the notch of the C-shaped carrier seat 213, it can be sliced by the sausage slicing knife 222.

Herein, through the configuration of the slicing anti-drop seat 223, the sausage slicing knife 222 can smoothly drop the sausage 140 slices cut from the sausage 140 into the sausage slice feeding channel 240, so that the sausage 140 slices will not be stuck between the sausage slicing knife 222 and the C-shaped carrier seat 213.

It should be pointed out that the slicing vibration member 250 includes a vibration motor 251 and a vibration base 252. The sausage slice feeding channel 240 is mounted at the bottom of the sausage slicing base 210 through the vibration base 252, and the vibration motor 251 is mounted on the vibration base 252.

Specifically, the vibration motor 251 can drive the vibration base 252 to vibrate at a high frequency, so that the sausage slice feeding channel 240 is in a vibrating state, so that when the sausage 140 slices drop into the sausage slice feeding channel 240, they will not stick to an inner wall of the sausage slice feeding channel 240, so that the sausage slices 140 drop smoothly.

As shown in FIGS. 1 to 20, in an optional solution of the present embodiment, the sausage storage assembly 100 includes a sausage carrier bracket 110, a sausage positioning member 120 and a sausage auxiliary positioning plate 130. The sausage carrier bracket 110 is provided on the sausage rotating quick-release seat 233. The sausage carrier bracket 110 has a plurality of guide posts 111, each guide post 111 is slidably provided with the sausage positioning member 120, and the sausage positioning member 120 can fix an upper end of the sausage 140. The sausage auxiliary positioning plate 130 is slidably provided on the guide post 111, and the sausage auxiliary positioning plate 130 can define a lower end of the sausage 140. The sausage auxiliary positioning plate 130 and the sausage positioning member 120 both can slide separately. The sausage auxiliary positioning plate 130 is provided with a plurality of sausage spaces 131 for accommodating the sausages 140.

Specifically, during operation, the staff loads the sausage 140 on a slicing storage device of the sausage 140, and then mounts the slicing storage device of the sausage 140 on a slicer of the sausage 140. During a process of loading the sausage 140 by the staff, the staff first uses the sausage auxiliary positioning plate 130 to lift a positioning bracket of the sausage 140 to an uppermost end, then clamps a top of the sausage 140 on the sausage positioning member 120, and then lowers the sausage auxiliary positioning plate 130 to a lower end, thereby fixing the upper and lower ends of the sausage 140 through the sausage positioning member 120 and the sausage auxiliary positioning plate 130, so as to facilitate machine cutting. During a cutting process, as the sausage 140 is cut, the sausage positioning member 120 can be lowered along the guide post 111. During this process, the sausage auxiliary positioning plate 130 is always located below the lower end of the sausage 140, thereby ensuring that the sausage 140 is easy to cut stably and improves operating efficiency.

Herein, the sausage auxiliary positioning plate 130 and the sausage positioning member 120 both can slide separately, the sausage positioning member 120 is located above the sausage auxiliary positioning plate 130, the sausage auxiliary positioning plate 130 can support the sausage positioning member 120, and the sausage auxiliary positioning plate 130 can drive the sausage positioning member 120 to rise. Descent of the sausage auxiliary positioning plate 130 is not constrained by the sausage positioning member 120, and descent of the sausage positioning member 120 is constrained by the sausage auxiliary positioning plate 130.

As shown in FIGS. 1 to 20, in an optional solution of the present embodiment, the sausage carrier bracket 110 includes a sausage carrier base 112, a sausage carrier top plate 113 and a plurality of guide posts 111. One end of each guide post 111 is provided on the sausage carrier base 112, and the other end is provided on the sausage carrier top plate 113. The plurality of guide posts 111 are evenly distributed along a circumferential direction of the sausage carrier base 112. The sausage carrier base 112 is provided with a quick-release interface 114 that can be adapted to the sausage rotating quick-release seat 233.

Specifically, the quick-release interface 114 is provided on the sausage carrier base 112. The configuration of the quick-release interface 114 enables the staff to quickly mount the sausage storage assembly 100 on the sausage rotating quick-release seat 233, thereby improving the operating efficiency.

As shown in FIGS. 1 to 20, in an optional solution of the present embodiment, the sausage positioning member 120 includes a counterweight seat 121, a sausage fixing clip 122 and a sausage top fixing seat 123. The counterweight seat 121 is slidably provided on the guide post 111, the counterweight seat 121 is located above the sausage auxiliary positioning plate 130, and the sausage auxiliary positioning plate 130 can support the counterweight seat 121 to rise. The sausage fixing clip 122 is fixedly provided on the counterweight seat 121. The sausage fixing clip 122 can clamp the sausage 140. The sausage top fixing seat 123 is fixedly provided on the counterweight seat 121, and the sausage top fixing seat 123 can fix a top of the sausage 140. The sausage top fixing seat 123 includes a sausage top plate 124 and a sausage fixing nail 125, where the sausage top plate 124 is fixedly provided on the counterweight seat 121, the sausage fixing nail 125 is provided on the sausage top plate 124, and the sausage fixing nail 125 can be inserted into the sausage 140 from the top of the sausage 140.

Specifically, each guide post 111 is slidably sleeved with the counterweight seat 121, and the counterweight seat 121 makes the sausage positioning member 120 have a tendency to slide downward as a whole under an action of its own gravity, so as to ensure that the sausage 140 provided on the sausage positioning member 120 can move downward stably, thereby ensuring continuity and stability of cutting.

Herein, the sausage fixing nail 125 of the sausage top fixing seat 123 can be inserted into the sausage 140, so as to cooperate with the sausage fixing clip 122 to fix the sausage 140 and ensure the stability of the sausage 140.

As shown in FIGS. 1 to 20, in an optional solution of the present embodiment, the sauce application assembly 300 includes a sauce storage member 310, a sauce discharge member 320, a sauce power member, an applicator 330 and an application drive member 340. The sauce storage member 310 is provided on the mounting base 10. The sauce discharge member 320 is provided on the mounting base 10. The sauce discharge member 320 is connected to the sauce storage member 310 through the sauce power member. The application drive member 340 is provided on the mounting base 10. The applicator 330 is provided at a bottom of the mounting base 10. The applicator 330 is connected to the application drive member 340 in a transmission manner. The sauce discharge member 320 adopts a discharge pipe. A mounting hole 321 for mounting the sauce discharge member 320 is provided on the mounting base 10, and a plurality of pressure relief grooves 322 are provided at an end of the discharge pipe, where an extension direction of the pressure relief grooves 322 is consistent with an extension direction of the discharge pipe.

Specifically, when producing pizza, the sauce power member transfers the sauce in the sauce storage member 310 to the sauce discharge member 320, and the sauce flows downward along the sauce discharge member 320, thereby dropping on the pizza crust below a pizza sauce application device, and then the application drive member 340 drives the applicator 330 to swing, so that the applicator 330 can be in contact with the pizza crust, and then when other structures drive the pizza crust to rotate, the applicator 330 can evenly apply the sauce on the pizza crust. Through such configuration, the efficiency and uniformity of sauce applying are improved.

Herein, a plurality of groups of sauce storage members 310, sauce discharge members 320, sauce power members, applicators 330 and application drive members 340 are mounted on the mounting base 10, so as to realize the applying of multiple sauces.

Herein, the sauce power member can adopt a peristaltic pump, and in addition, those skilled in the art can make a choice according to actual needs.

It should be pointed out that the pizza crust carrier assembly 400 for carrying the pizza crust can drive the pizza crust to rotate, so as to cooperate with the pizza sauce application device to apply the pizza crust with the sauce.

In addition, the mounting hole 321 is provided on the mounting base 10, the sauce discharge member 320 is inserted into the mounting hole 321, and then the sauce power member can transfer the sauce in the sauce storage member 310 into the sauce discharge member 320, and then the sauce is directly discharged to the pizza crust below through the sauce discharge member 320.

Herein, the sauce discharge member 320 is of a straight pipe structure, in which there is no valve and no baffle, so that the sauce in the sauce discharge member 320 can be sprayed on the pizza crust below to the greatest extent. Moreover, through such configuration, the sauce in the sauce discharge member 320 can be prevented from being blocked, which is convenient for the staff to maintain the sauce discharge member 320 later.

In addition, a plurality of pressure relief grooves 322 are provided at the end of the discharge pipe. Through the configuration of the pressure relief grooves 322, the sauce can be prevented from accumulating and blocking the end of the sauce discharge member 320.

As shown in FIGS. 1 to 20, in an optional solution of the present embodiment, the applicator 330 includes an application base 331 and an application scraper 332. The application base 331 is provided on the mounting base 10, the application drive member 340 is provided on the application base 331, and the application scraper 332 is connected to the application drive member 340 in a transmission manner, so that the application drive member 340 can drive the application scraper 332 to swing. The application base 331 is provided at the bottom of the mounting base 10, and a mounting cavity 333 for mounting the application drive member 340 is formed between the application base 331 and the mounting base 10.

Specifically, the application drive member 340 adopts a rotating motor or a servo motor, and the application drive member 340 can drive the application scraper 332 to swing, so that the application scraper 332 can be in contact with the pizza crust below, so as to better apply the sauce.

As shown in FIGS. 1 to 20, in an optional solution of the present embodiment, the pizza crust carrier assembly 400 includes a first direction moving member 440, a second direction moving member 450, a pizza rotating member 410, a pizza supporting base 420 and a weighing member 430. The first direction moving member 440 is provided on the mounting base 10, the second direction moving member 450 is provided on the first direction moving member 440, and a first direction intersects with a second direction. The pizza rotating member 410 is provided on the second direction moving member 450. The pizza supporting base 420 is provided on the pizza rotating member 410. The weighing member 430 is provided between the pizza supporting base 420 and the pizza rotating member 410. The pizza rotating member 410 includes a rotating base 411, a pizza rotating motor 412, a rotating socket 413 and a rotating drive shaft 414. The rotating base 411 is provided on the second direction moving member 450. The pizza rotating motor 412 is provided on the rotating base 411. The pizza rotating motor 412 is connected to the rotating socket 413 in a transmission manner. The rotating drive shaft 414 is inserted in the rotating socket 413. The pizza supporting base 420 is provided on the rotating drive shaft 414.

Specifically, the staff puts a pizza plate containing the pizza crust on the pizza supporting base 420, and then starts the equipment. The first direction moving member 440 and the second direction moving member 450 can move the pizza supporting base 420 to a specified position, and then the pizza rotating member 410 rotates to drive the pizza supporting base 420 to rotate, so that the pizza crust on the pizza supporting base 420 rotates, so as to better hold the sauce, the sausage 140 and other toppings. When the pizza supporting base 420 supports the pizza crust, the pizza supporting base 420 can press the weighing member 430 provided between the pizza supporting base 420 and the pizza rotating member 410, and the pizza crust is weighed through the weighing member 430. Then, when adding each topping later, a weight can be accurately obtained according to the weighing member 430. The staff does not need to weigh manually repeatedly, which improves the operating efficiency.

Herein, the first direction moving member 440 includes a first direction lead screw, a first direction lead screw nut, a first direction drive motor 441 and a first direction base 442. The first direction base 442 is provided on the mounting base 10, and the first direction lead screw and the first direction drive motor 441 are provided on the first direction base 442. The first direction lead screw and the first direction drive motor 441 are connected in a transmission manner. The first direction lead screw nut is sleeved on the first direction lead screw, and the second direction moving member 450 is provided on the first direction lead screw nut.

Herein, the second direction moving member 450 includes a second direction lead screw 451, a second direction lead screw nut 452, a second direction drive motor 453 and a second direction base 454. The second direction base 454 is provided on the first direction lead screw nut, the second direction lead screw 451 and the second direction drive motor 453 are provided on the second direction base 454. The second direction lead screw 451 and the second direction drive motor 453 are connected in a transmission manner. The second direction lead screw nut 452 is sleeved on the second direction lead screw 451, and the rotating base 411 is provided on the second direction lead screw nut 452.

Herein, the pizza supporting base 420 is provided with a plurality of carrier ring seats 421 for carrying pizza plates, and the plurality of carrier ring seats 421 are provided concentrically. The carrier ring seats 421 of different sizes can bear the pizza plates of different sizes.

As shown in FIGS. 1 to 20, in an optional solution of the present embodiment, the weighing member 430 includes a weighing base 431, a weighing sensor 432 and a weighing protective sleeve 433. The weighing base 431 is provided on the rotating base 411. The weighing protective sleeve 433 is fixedly provided at a bottom end of the rotating drive shaft 414. The weighing sensor 432 is provided in the weighing protective sleeve 433. The weighing sensor 432 can abut against the weighing base 431. A weighing guide post 434 is provided on the weighing base 431, the rotating base 411 is provided with a weighing guide hole for the weighing guide post 434 to pass therethrough, and a limit stop seat 435 is provided at one end of the weighing guide post 434 away from the weighing base 431. A lifting follower pulley 436 is provided on the weighing base 431, and a lifting trapezoidal seat 437 that can be adapted to the lifting follower pulley 436 is provided on the second direction base 454 of the second direction moving member 450, so that the pizza supporting base 420 can be lifted upward when receiving the toppings, and the pizza supporting base 420 can be lowered when receiving the pizza crust.

Specifically, the pizza rotating motor 412 can drive the pizza supporting base 420 to rotate through the rotating drive shaft 414.

Herein, a guide groove is provided on an inner wall of the rotating socket 413, and a sliding key that is adapted to the guide groove is provided on the rotating drive shaft 414.

Herein, the rotating drive shaft 414 can slide up and down in the rotating socket 413, so that the pizza supporting base 420, when carrying the pizza plate containing the pizza crust, can press the weighing member 430 below.

Specifically, one end of the rotating drive shaft 414 can carry the pizza supporting base 420, and the rotating drive shaft 414 is pressed down and can press the weighing protective sleeve 433. The weighing protective sleeve 433 can press the weighing sensor 432 on the weighing base 431, thereby triggering the weighing sensor 432, so as to accurately know a weight of the toppings dispensed on the pizza crust, so that the quality of the produced pizzas can be kept consistent.

Specifically, when the second direction moving member 450 drives the pizza supporting base 420 to extend outward, the staff places the pizza plate containing the pizza crust on the pizza supporting base 420, and then the second direction moving member 450 drives the pizza supporting base 420 to retract. During a retraction process, the lifting follower pulley 436 provided on the weighing base 431 will abut against the lifting trapezoidal seat 437 on the second direction base 454, so that the lifting follower pulley 436 moves upward, the lifting follower pulley 436 can drive the weighing base 431 to rise, and the weighing base 431 can drive the rotating drive shaft 414 to rise, so that the pizza supporting base 420 rises, and thereby the pizza crust on the pizza supporting base 420 rises, which is convenient for the equipment to carry out subsequent topping application operation.

During a rising process of the weighing base 431, the weighing guide post 434 rises along the weighing guide hole, thereby ensuring smooth rise of the rotating drive shaft 414.

Finally, it should be noted that the above embodiments are only used to illustrate the technical solutions of the present disclosure, rather than to limit them. Although the present disclosure has been described in detail with reference to the aforementioned embodiments, those ordinarily skilled in the art should understand that they could still modify the technical solutions described in the aforementioned embodiments, or replace some or all of the technical features therein by equivalents. However, these modifications or replacements do not cause the essence of the corresponding technical solutions to deviate from the scope of the technical solutions of the embodiments of the present disclosure.

1. A pizza topping spreader, comprising: a mounting base, a sausage storage assembly, a sausage slicing assembly, a sauce application assembly and a pizza crust carrier assembly, wherein
the sausage slicing assembly, the sauce application assembly and the pizza crust carrier assembly are provided on the mounting base, and the pizza crust carrier assembly is located below the sausage slicing assembly and the sauce application assembly;
the sausage slicing assembly comprises a sausage slicing base, a sausage slicing member, a sausage rotating member, a sausage slice feeding channel and a slicing vibration member, wherein the sausage slicing base is provided on the mounting base, a sausage feeding port is provided on the sausage slicing base, the sausage slice feeding channel is provided at the sausage feeding port through the slicing vibration member, the sausage slicing member and the sausage rotating member are both provided on the sausage slicing base, and the sausage slicing member and the sausage rotating member are respectively provided on two sides of the sausage feeding port; and
the sausage storage assembly is mounted on the sausage rotating member.

2. The pizza topping spreader according to claim 1, wherein the sausage slicing member comprises a sausage slicing motor and a sausage slicing knife, wherein
the sausage slicing motor is provided at a bottom of the sausage slicing base, the sausage slicing knife is connected to the sausage slicing motor in a transmission manner, the sausage slicing knife is located above the sausage slicing base, and a knife protection cover for covering the sausage slicing knife is provided on the sausage slicing base.

3. The pizza topping spreader according to claim 2, wherein the sausage rotating member comprises a sausage rotating motor, a sausage rotating shaft and a sausage rotating quick-release seat, wherein
the sausage rotating motor is provided at the bottom of the sausage slicing base, the sausage rotating shaft is connected to the sausage rotating quick-release seat, and the sausage rotating quick-release seat is located above the sausage slicing base;
a C-shaped carrier seat for carrying sausages is provided on the sausage slicing base and located outside the sausage rotating quick-release seat, a notch of the C-shaped carrier seat corresponds to the sausage feeding port, a bottom surface of the sausage slicing knife is located below a top surface of the C-shaped carrier seat, and a top surface of the sausage slicing knife is located above the top surface of the C-shaped carrier seat; and
the sausage slicing member further comprises a slicing anti-drop seat, wherein the slicing anti-drop seat is detachably provided on the sausage slicing base, the slicing anti-drop seat is located at an edge of the sausage feeding port, the slicing anti-drop seat is adjacent to the C-shaped carrier seat, and the sausage slicing knife, when rotating, passes through the sausage feeding port and faces towards the slicing anti-drop seat.

4. The pizza topping spreader according to claim 3, wherein the sausage storage assembly comprises a sausage carrier bracket, a sausage positioning member and a sausage auxiliary positioning plate, wherein
the sausage carrier bracket is provided on the sausage rotating quick-release seat;
the sausage carrier bracket has a plurality of guide posts, each of the plurality of guide posts is slidably provided with the sausage positioning member, and the sausage positioning member is allowed to fix an upper end of the sausage;
the sausage auxiliary positioning plate is slidably provided on the guide post, and the sausage auxiliary positioning plate is allowed to limit a lower end of the sausage;
the sausage auxiliary positioning plate and the sausage positioning member are both allowed to slide separately; and
the sausage auxiliary positioning plate is provided with a plurality of sausage spaces for accommodating the sausages.

5. The pizza topping spreader according to claim 4, wherein the sausage carrier bracket comprises a sausage carrier base, a sausage carrier top plate and a plurality of guide posts, wherein
the plurality of guide posts each have a first end provided on the sausage carrier base, and a second end provided on the sausage carrier top plate;
the plurality of guide posts are evenly distributed along a circumferential direction of the sausage carrier base; and
a quick-release interface that is allowed to be adapted to the sausage rotating quick-release seat is provided on the sausage carrier base.

6. The pizza topping spreader according to claim 5, wherein the sausage positioning member comprises a counterweight seat, a sausage fixing clip and a sausage top fixing seat, wherein
the counterweight seat is slidably provided on the guide post, the counterweight seat is located above the sausage auxiliary positioning plate, the sausage auxiliary positioning plate is allowed to support the counterweight seat to rise, the sausage fixing clip is fixedly provided on the counterweight seat, the sausage fixing clip is allowed to clamp the sausage, the sausage top fixing seat is fixedly provided on the counterweight seat, and the sausage top fixing seat is allowed to fix a top of the sausage; and
the sausage top fixing seat comprises a sausage top plate and a sausage fixing nail, wherein the sausage top plate is fixedly provided on the counterweight seat, the sausage fixing nail is provided on the sausage top plate, and the sausage fixing nail is allowed to be inserted into the sausage from the top of the sausage.

7. The pizza topping spreader according to claim 1, wherein the sauce application assembly comprises a sauce storage member, a sauce discharge member, a sauce power member, an applicator and an application drive member, wherein
the sauce storage member is provided on the mounting base, the sauce discharge member is provided on the mounting base, the sauce discharge member is connected to the sauce storage member through the sauce power member, the application drive member is provided on the mounting base, the applicator is provided at a bottom of the mounting base, and the applicator is connected to the application drive member in a transmission manner; and
the sauce discharge member adopts a discharge pipe, the mounting base is provided with a mounting hole for mounting the sauce discharge member, and an end of the discharge pipe is provided with a plurality of pressure relief grooves, wherein an extension direction of the plurality of pressure relief grooves is consistent with an extension direction of the discharge pipe.

8. The pizza topping spreader according to claim 7, wherein the applicator comprises an application base and an application scraper, wherein
the application base is provided on the mounting base, the application drive member is provided on the application base, and the application scraper is connected to the application drive member in a transmission manner, wherein the application drive member is allowed to drive the application scraper to swing; and
the application base is provided at the bottom of the mounting base, and a mounting cavity for mounting the application drive member is formed between the application base and the mounting base.

9. The pizza topping spreader according to claim 1, wherein the pizza crust carrier assembly comprises a first direction moving member, a second direction moving member, a pizza rotating member, a pizza supporting base and a weighing member, wherein
the first direction moving member is provided on the mounting base, the second direction moving member is provided on the first direction moving member, a first direction intersects with a second direction, the pizza rotating member is provided on the second direction moving member, the pizza supporting base is provided on the pizza rotating member, and the weighing member is provided between the pizza supporting base and the pizza rotating member; and
the pizza rotating member comprises a rotating base, a pizza rotating motor, a rotating socket and a rotating drive shaft, wherein the rotating base is provided on the second direction moving member, the pizza rotating motor is provided on the rotating base, the pizza rotating motor is connected with the rotating socket in a transmission manner, the rotating drive shaft is inserted in the rotating socket, and the pizza supporting base is provided on the rotating drive shaft.

10. The pizza topping spreader according to claim 9, wherein the weighing member comprises a weighing base, a weighing sensor and a weighing protective sleeve, wherein
the weighing base is provided on the rotating base, the weighing protective sleeve is fixedly provided at a bottom end of the rotating drive shaft, the weighing sensor is provided in the weighing protective sleeve, and the weighing sensor is allowed to abut against the weighing base;
a weighing guide post is provided on the weighing base, a weighing guide hole for the weighing guide post to pass therethrough is provided on the rotating base, and a limit stop seat is provided at one end of the weighing guide post away from the weighing base; and
a lifting follower pulley is provided on the weighing base, a lifting trapezoidal seat that is allowed to be adapted to the lifting follower pulley is provided on a second direction base of the second direction moving member, wherein the pizza supporting base is allowed to be lifted upward when receiving toppings, and the pizza supporting base is allowed to be lowered when receiving a pizza crust.

11. The pizza topping spreader according to claim 1, wherein the slicing vibration member comprises a vibration motor and a vibration base, the sausage slice feeding channel is mounted at a bottom of the sausage slicing base through the vibration base, the vibration motor is mounted on the vibration base, and the vibration motor is allowed to drive the vibration base to vibrate at a high frequency, wherein the sausage slice feeding channel is in a vibrating state.

12. The pizza topping spreader according to claim 4, wherein the sausage positioning member is located above the sausage auxiliary positioning plate, the sausage auxiliary positioning plate is allowed to support the sausage positioning member, and the sausage auxiliary positioning plate is allowed to drive the sausage positioning member to rise.

13. The pizza topping spreader according to claim 9, wherein the first direction moving member comprises a first direction lead screw, a first direction lead screw nut, a first direction drive motor and a first direction base, wherein the first direction base is provided on the mounting base, the first direction lead screw and the first direction drive motor are provided on the first direction base, the first direction lead screw and the first direction drive motor are connected in a transmission manner, the first direction lead screw nut is sleeved on the first direction lead screw, and the second direction moving member is provided on the first direction lead screw nut; and
the second direction moving member comprises a second direction lead screw, a second direction lead screw nut, a second direction drive motor and a second direction base, wherein the second direction base is provided on the first direction lead screw nut, the second direction lead screw and the second direction drive motor are provided on the second direction base, the second direction lead screw and the second direction drive motor are connected in a transmission manner, the second direction lead screw nut is sleeved on the second direction lead screw, and the rotating base is provided on the second direction lead screw nut.

14. The pizza topping spreader according to claim 9, wherein the pizza supporting base is provided with a plurality of carrier ring seats for carrying pizza plates, and the plurality of carrier ring seats are provided concentrically.

15. The pizza topping spreader according to claim 9, wherein a guide groove is provided on an inner wall of the rotating socket, and a sliding key that is adapted to the guide groove is provided on the rotating drive shaft.
